(19) United States
(12) Patent Application Publication
(10) Pub. No.: US 2023/0038725 A1
(43) Pub. Date: Feb. 9, 2023

(54) N-PROPANOL/H2O MIXED SOLVENT COMPOSITIONS FOR MEMBRANE ELECTRODE ASSEMBLIES

(71) Applicant: The Trustees of Indiana University, Indianapolis, IN (US)

(72) Inventor: Jian Xie, Zionsville, IN (US)

(21) Appl. No.: 17/870,785

(22) Filed: Jul. 21, 2022

Related U.S. Application Data
(60) Provisional application No. 63/224,333, filed on Jul. 21, 2021.

(51) Int. Cl. H01M 4/86; H01M 8/1004; H01M 4/88; H01M 4/90

(52) U.S. Cl. CPC H01M 4/8605; H01M 8/1004; H01M 4/8835; H01M 4/9075; H01M 4/8892; H01M 2300/0082

(57) ABSTRACT

A series of catalyst inks comprising n-propanol and water are disclosed. The impact of these inks on structure and morphology of catalyst layers is discussed, as well as applications of the catalyst ink compositions in polymer electrolyte membrane fuel cells.

### REFERENCE TO RELATED APPLICATION

This application claims the benefit of U.S. Provisional Application No. 63/224,333 entitled Effects of Ink Formulation on Constructing Catalyst Layers for High-Performance PEM Fuel Cells filed on Jul. 21, 2021, which is incorporated herein by reference in its entirety and for all purposes.

### FIELD

The present disclosure is related to membrane electrode assemblies (MEA)s and, in particular, to high-performance catalyst ink compositions and applications for these compositions.

### BACKGROUND

Polymer electrolyte membrane (PEM) fuel cells are an attractive and leading technology for energy conversion with advantages of high efficiency and low emission. As PEM fuel cells are increasingly driven by commercialization, the focus of research and development has shifted towards reducing cost and improving performance. The cathode catalyst layer in a membrane electrode assembly (MEA), at which oxygen reduction reaction (ORR) takes place, is a key component of PEM fuel cells. Catalyst layers are formed by depositing and solidifying a catalyst ink, which consists of catalyst powder, ionomer and dispersing solvent, onto gas diffusion layer or membrane. An ideal catalyst layer needs to have maximized catalyst/ionomer interface as reaction sites for ORR, good ionomer network for proton conduction, and appropriate pore structure to facilitate mass transport of reactant gases and product water. The microstructure of a catalyst layer depends on the catalyst ink, particularly, the dispersion of catalyst powder and ionomer particles in a solvent system, which determine the catalyst/ionomer interface, ionomer network, and pore structure of the resulting catalyst layer.

Effective ink formulations break up the large agglomerates of catalyst and ionomer to achieve the desired particle size and ink viscosity for different coating methods. The physical properties of dielectric constant and solubility of the dispersing solvent have significant impacts on the size and morphology of the catalyst and ionomer in the ink. The dielectric constant of a solvent is closely related to its polarizability, which affects the solubility and dispersibility of the solvent to the molecules/ions of another substance. Two most commonly used MEA fabrication techniques are gas diffusion electrode (GDE) and catalyst-coated membrane (CCM). CCMs can be fabricated using a variety of different techniques, such as decal transfer method, hand-painting, machine spraying/coating, or screen-printing.

Although significant efforts have been made to obtain a good catalyst ink for MEA fabrication, a clear understanding of the property (ink)—structure (catalyst layer)—performance (MEA) relationship is still needed.

### SUMMARY OF THE DISCLOSURE

The present disclosure discusses the relationship between property (ink)—structure (catalyst layer)—performance (MEA) relationship toward the efficient design of best-performing electrodes. A series of MEAs were fabricated using CCM method from catalyst inks obtained by dispersing commercial 20 wt. % Pt/C catalyst and low-EW (830-EW) ionomer in n-PA/H₂O mixed solvents with various compositions. The effects of solvent composition on the dispersion of catalyst and ionomer particles, the microstructure of catalyst layers, and MEA performance were systematically investigated.

It has been found that catalyst inks compositions comprising n-propanol and water strongly influence the structure and morphology of catalyst layers in membrane electrode assemblies, thereby providing improved polarization losses of cell activation and mass transport.

In one form thereof, the present disclosure provides a catalyst ink composition comprising n-propanol and water, wherein the water is present in an amount of 90 wt. % based on the total weight of the composition.

In another form thereof, the present disclosure provides a catalyst layer in a membrane electrode assembly comprising a catalyst ink composition comprising n-propanol and water, wherein the water is present in an amount of 90 wt. % based on the total weight of the composition

In another form thereof, the present disclosure provides a polymer electrolyte membrane fuel cell comprising a catalyst ink composition comprising n-propanol and water, wherein the water is present in an amount of 90 wt. % based on the total weight of the composition.

### BRIEF DESCRIPTION OF THE DRAWINGS

FIG. 1 illustrates in (a) H₂/O₂ polarization curves and in (b) the corresponding Tafel plots of MEAs fabricated with different n-PA/H₂O mixed solvents. Testing conditions: 0.1 mg·cm⁻² (cathode/anode Pt loadings), Nafion-212, H₂/O₂ (200/400 sccm), 80° C., 100% RH, 150 kPa (absolute) pressure. Window (c) provides a comparison of electrochemical surface area (ECSA) and mass activity at 0.9 V_{iR free}.

FIG. 2 illustrates in (a) Current density as a function of H₂O content in the mixed solvents plotted at different voltages, in (b) Mass transport loss of MEAs fabricated with different n-PA/H₂O mixed solvents. Both (a) and (b) are derived from H₂/O₂ polarization curves in FIG. 1.

FIG. 3 illustrates in (a) H₂/air polarization and power density curves of MEAs fabricated with different n-PA/H₂O mixed solvents. Test conditions: 0.1 mg·cm⁻² (cathode/anode Pt loadings), Nafion-212, H₂/air (500/1000 sccm), 80° C., 100% RH, 150 kPa (absolute) pressure. (b) Nyquist plots obtained at 1.0 A·cm⁻² from 0.1 Hz to 10 kHz in the corresponding H₂/air fuel cell tests. The symbols are measured data, while the solid lines are fitted data using the inset equivalent circuit. (c) Variations of the cathode resistance (R_{cathode}), mass transport resistance (Rₘₜ) and peak power density with H₂O content in the n-PA/H₂O mixed solvents.

FIG. 4 illustrates USAXS curves of (a) ionomer solutions and (b) catalyst inks for different n-PA/H₂O mixed solvents. The inset in (b) shows a zoomed-in low-q region. (c) USAXS fitted average sizes of ionomer aggregates and catalyst-ionomer aggregates. The concentrations of ionomer and catalyst are equivalent to those of catalyst inks used for MEA fabrication.

FIG. 5 illustrates Cryo-TEM images of (a) ionomer solution and (b) catalyst ink with n-PA/H₂O mixed solvent containing 90 wt. % H₂O, as well as catalyst inks with (c) pure n-PA and (d) pure H₂O. The concentrations of ionomer and catalyst are equivalent to those of catalyst inks used for MEA fabrication.

FIG. 6 illustrates in (a-e) top view and in (f-j) cross-sectional SEM images of the catalyst layers fabricated with different n-PA/H₂O mixed solvents. (a, f) n-PA; (b, g) 20 wt. % H₂O; (c, h) 50 wt. % H₂O; (d, i) 70 wt. % H₂O; (e, j) H₂O.

FIG. 7 illustrates in (a) specific pore volume distribution curves of the catalyst layers fabricated with different n-PA/H₂O mixed solvents and in (b) variations of the specific volumes of primary pore and secondary pore, as well as the boiling point with H₂O content in the mixed solvents.

### DETAILED DESCRIPTION

1. Catalyst Ink Preparation

Catalyst inks were prepared by dispersing commercial 20 wt. % Pt/C (Vulcan XC-72, E-TEK) catalyst and 6 wt. % ionomer solution (Aquivion, 830-EW) in different n-PA/H₂O mixed solvents. A total of 6 catalyst inks, in which the n-PA/H₂O mixed solvents containing 0, 20, 50, 70, 90, and 100 wt. % H₂O was used for the fabrication of cathode catalyst layers. The n-PA/H₂O mixed solvent with 50 wt. % H₂O was used for anode catalyst layer preparation. For all catalyst inks, the catalyst content was 2.0 mg·mL⁻¹, and the weight ratio of ionomer to carbon was controlled to 0.45. Before spraying, all catalyst inks were homogenized using an ultrasonic bath for 60 min.

As described herein, the catalyst ink compositions may comprise n-propanol in an amount as low as 0 wt. %, 10 wt. %, 20 wt. %, 30 wt. %, 40 wt. %, 50 wt. %, or as high as 60 wt. %, 70 wt. %, 80 wt. %, 90 wt. %, 100 wt. %, or within any range encompassed by any two of the foregoing values as endpoints.

As described herein, the catalyst ink compositions may comprise water in an amount as low as 0 wt. %, 10 wt. %, 20 wt. %, 30 wt. %, 40 wt. %, 50 wt. %, or as high as 60 wt. %, 70 wt. %, 80 wt. %, 90 wt. %, 100 wt. %, or within any range encompassed by any two of the foregoing values as endpoints.

II. MEA Fabrication

The catalyst inks were ultrasonically sprayed onto Nafion-212 membranes using an ExactCoat spray coating system (Sono-Tek, NY). During the ultrasonic spraying, the Nafion membranes were placed on a hot vacuum plate with surface temperature of 70° C. For both anode and cathode catalyst layers, the Pt loadings were controlled to be 0.10±0.02 mg·cm⁻² by weighing the Nafion membrane before and after coating. The CCMs were sandwiched by two gas diffusion layers (Sigracet 29BC, SGL Global, Germany) without hot pressing.

III. Fuel Cell Testing

The MEA was assembled into a fuel cell hardware with an active area of 5.0 cm² and tested on a model 850e fuel cell test system (Scribner Associates, Inc., NC). Throughout the tests, the gases of anode and cathode were humidified at 80° C. (i.e. 100% RH) except for ECSA measurement. The MEA was activated (break-in) using potential step mode from 0.35 to 0.75 V in 0.05 V increments every 5 min for 16 hours with H₂/air flowrates of 200/400 standard cubic centimeter per minute (sccm) at a cell temperature of 80° C. After break-in, the electrochemical active surface area (ECSA) was determined using the electrochemical hydrogen adsorption method by employing a cyclic voltammetry (CV) between 0.05 and 0.60 V with a scan rate of 20 mV·s⁻¹ under 150 kPa (absolute) at a cell temperature of 30° C. Prior to ECSA measurement, the cathode side was purged with N₂ until the open circuit voltage (OCV) dropped to below 0.15 V. The CV measurement was carried out using an electrochemical workstation (Solartron 1287BZ, AMETEK, PA).

Fuel cell polarization curves were recorded using potential step mode with 50 mV/point (holding 1 min at each point). The H₂/O₂ polarization curves were recorded with anode/cathode flowrates of 200/400 sccm under 150 kPa (absolute) pressure. The cell resistance was monitored during the acquisition of polarization curves using the current interrupt method. The iR-corrected polarization curves were used for analyzing the characteristics of kinetic activity and mass transport. Mass activities were reported at 0.90 V after applying iR corrections. The H₂/air polarization curves were measured at a constant H₂/air flowrate of 500/1000 sccm under 150 kPa (absolute) pressure. During the performance testing, the cell temperature was maintained to be 80° C. The electrochemical impedance spectroscopies were collected at 1.0 A·cm⁻² by scanning frequency from 104 Hz to 0.1 Hz.

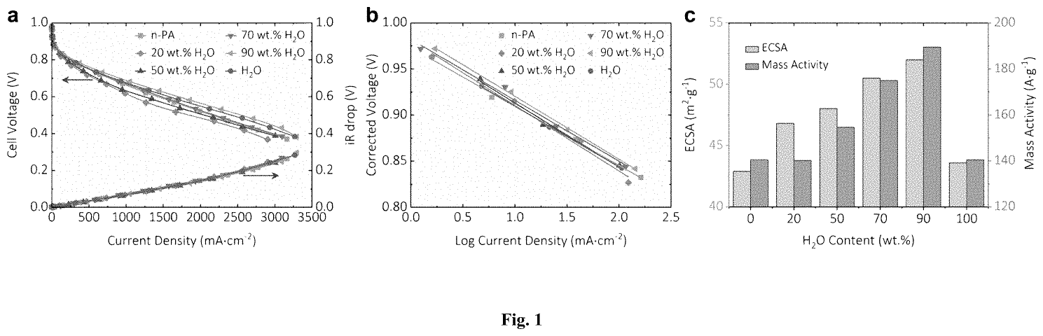

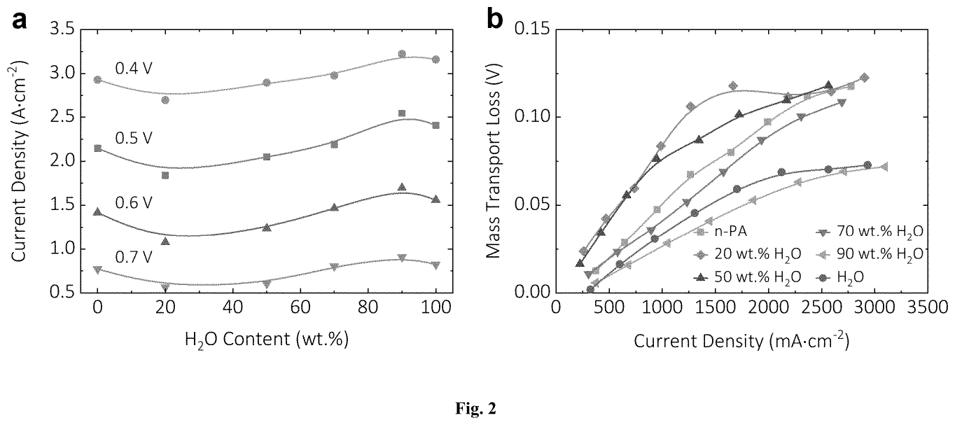

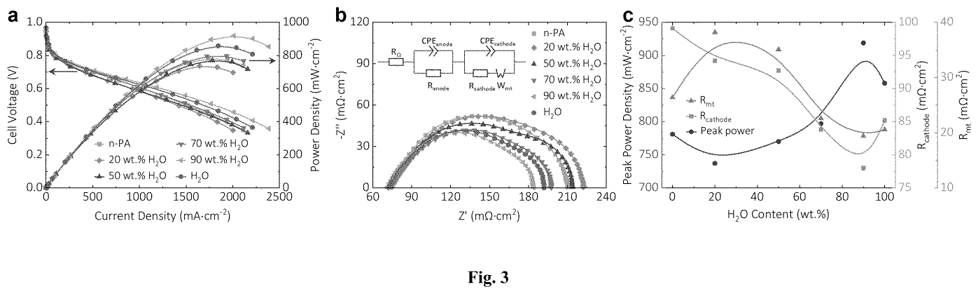

To determine the H₂/air performances, the polarization and power density curves were measured, as shown in FIG. 3(a). Compared with FIG. 1(a), the MEA performances with air were much lower. The peak power density varied from 737 to 919 mW cm⁻², and the current density at 0.6 V ranged from 914 to 1229 mA cm⁻², with the alteration of H₂O content. The MEA with 90 wt. % H₂O achieved the best performance, showing the highest peak power density of 919 mW·cm⁻² and the largest current density of 1229 mA·cm⁻² at 0.6 V. To analyze the H₂/air performances given in FIG. 3(a), the electrochemical impedance spectroscopies were collected at 1.0 A cm⁻² from 10 kHz to 0.1 Hz, and fitted using an equivalent circuit described previously.³⁶ The results are presented as Nyquist plots in FIG. 3(b). In the inset equivalent circuit, R_{Ω} represents the ohmic resistance arising from cell components and the contact resistance between the components. R_{anode} and R_{cathode} are Faradaic resistances, which reflect the kinetics of the electrochemical reactions occurring on the anode and cathode sides, respectively. The constant phase element (CPE) reflects the capacitive nature of the porous catalyst layer. The finite Warburg circuit element (Wₘₜ) is used to model the cathode mass transport. This model neglects any mass transport loss arising from the anode, since the high flowrate of pure hydrogen used in this study minimized this effect. Nyquist plots in FIG. 3(b) show one impedance arc consisting of three composite semicircles. The impedance arc shrank with the improvement of MEA performance. The high frequency intercepts with the real axis in Nyquist plots are ohmic resistances (R_{Ω}), which varied slightly for different MEAs. The fitted values of R_{Ω} are 73.8˜77.5 mΩ·cm² for different MEAs. The impedance arcs at the high, medium and low frequency regions are related to resistances of anode activation, cathode activation and mass transport, respectively. The larger the arc, the greater the resistance of activation kinetics or mass transport. For all cases, the anode related semicircles are almost masked by the cathode semicircles, indicating the resistances of anode activation are significantly lower than that of cathode activation. The R_{anode} values slightly varied from 9.1 to 14.2 mΩ·cm² for different MEAs, due to the same anode catalyst layer were applied. To correlate the MEA performance with the impedance data, the Pₘₐₓ values from FIG. 3(a), as well as the R_{cathode} and Rₘₜ values from FIG. 3(b) are plotted against the H₂O contents in FIG. 3(c). The variation of R_{cathode} values was consistent with that of ORR kinetics data (FIG. 1(c)), and the variation of Rₘₜ values matched well with that of mass transport data in FIG. 2 (b). Except for the MEA fabricated with pure n-PA, the variations of R_{cathode} and Rₘₜ with H₂O content follow a similar trend. For the MEA with pure n-PA, the highest R_{cathode} was compensated by the relatively low Rₘₜ to some extent, leading to the improved performance as compared with 20 wt. % H₂O and 50 wt. % H₂O. Therefore, the H₂/air performance was jointly controlled by ORR kinetics and mass transport in the cathode. The R_{cathode} values varied from 78.0 to 99.1 mΩ·cm², and Rₘₜ values varied from 19.4 to 38.2 mΩ·cm², with the alteration of H₂O content. Both R_{cathode} and Rₘₜ reached the minimum values with 90 wt. % H₂O, resulted in the best performance.

IV. Ultrasmall Angle X-Ray Scattering

The X-ray scattering measurements were conducted at beamline 9ID-C at the Advanced Photon Source (APS), Argonne National Laboratory. The samples after sonication were collected into a glass capillary tube (1 mm diameter) and sealed with a rubber cap. The sample tubes were mounted in the beamline hutch and exposed to a 21 keV monochromatic X-ray beam. The scattered intensity was collected within a scattering vector range of 10⁻⁴ to 1 Å⁻¹ by using a Bonse-Hart camera setup for USAXS and a Pilatus 100 K detector for pinhole SAXS. The background scattering data from the capillary tube filled with the corresponding solvent (n-PA/H₂O) was recorded and subtracted from scattering data for each corresponding catalyst ink. The scattering data were analyzed in a modeling macro package Irena for data fitting and simulation on Igor Pro (WaveMetrics, OR) platform.

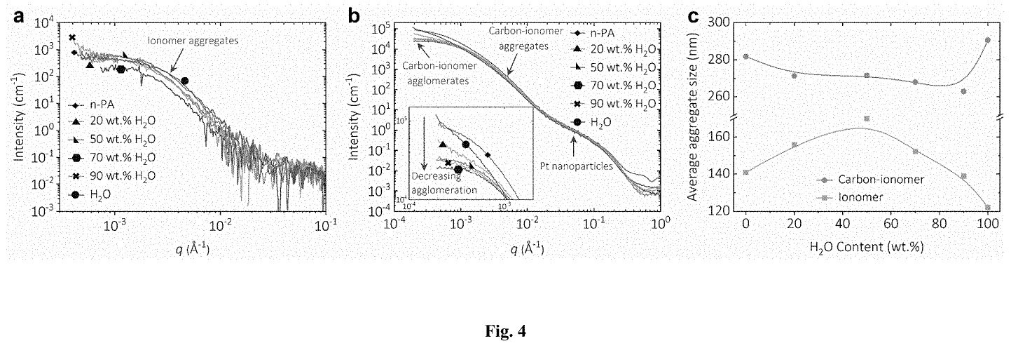

To better understand how solvent composition affects MEA performance, the particle/aggregate sizes of ionomer and catalyst in different mixed solvents which determine the catalyst/ionomer interface needs to be studied. Varying the H₂O content of the n-PA/H₂O mixed solvents modifies the physical properties including polarizability (dielectric constant) and solubility, which govern the size and morphology of ionomer and catalyst particles/aggregates in the dispersing solvent. For better discussion, the dielectric constant, solubility and boiling point of different mixed solvents are compiled in Table 2. The ultrasmall angle x-ray scattering (USAXS) curves, scattered intensity (l) versus scattering vector (q), of the pure ionomer dispersions in different mixed solvents are shown in FIG. 4(a). The scattering vector is reversely relative to particle size, and an increase in the scattered intensity at a given scattering vector indicates a larger population of particles at that size. As shown in FIG. 4(a), the intensity signals at high q (>0.01 Å⁻¹) region were weak and noisy, indicating quite low populations of primary ionomer particles in mixed solvents, which was not considered in the following discussion. The scattering data at low q (<0.01 Å⁻¹) region was analyzed using a unified fitting mode with Porod and Guinier scattering regimes. The fitting results demonstrated the power-law slope of P=4.0 with radius of gyration (R₉) from 61.1 to 85.0 nm for different mixed solvents, attributed to the formation of spherical ionomer aggregates. The average diameters of ionomer aggregates (twice the radius of gyration) are compared in FIG. 4(c). For the ionomer dispersion, the average size of ionomer aggregates increased from 141.0 nm in pure n-PA (0 wt. % H₂O) to 170.0 nm in 50 wt. % H₂O, and then decreased appreciably to 122.2 nm in pure H₂O (100 wt. % H₂O). This variation trend is similar to the observation on Nafion ionomers in different i-PA/H₂O mixed solvents. Due to the minimized difference between the solvent solubility and that of the sulfonate side chains, the mixed solvent of 50 wt. % H₂O has the highest compatibility with the sulfonate side chains of ionomer molecules. For the n-PA/H₂O mixed solvents, the dielectric constant increases with increasing the H₂O content, and the higher dielectric constant causes the ionomer molecules to dissociate more negatively charged —SO₃⁻ groups from —SO₃H groups. Therefore, the resulted higher inter-polymer negative charge repulsions lead to smaller ionomer aggregates in the mixed solvents with a higher H₂O content (>50 wt. %). On the other hand, the decreased size of ionomer aggregates with a lower H₂O content (<50 wt. %) could be attributed to the enhanced compatibility between the perfluorocarbon backbones and the mixed solvents containing more n-PA. In addition, the low-EW ionomer used in this study has more sulfonic acid groups and is therefore easier to be dispersed in H₂O-rich solvents compared with the traditional Nafion ionomer. This could explain the smallest size of ionomer aggregate in pure H₂O solvent. Previous studies reported that the smaller size of ionomer aggregates facilitated the ionomer infiltration inside the catalyst aggregates, resulting in better ionomer coverage on the catalyst surface and enhanced performance. However, no such correlation between the ionomer size and MEA performance was observed in this study. This may due to the catalyst/ionomer interface is not only related to the size of ionomer aggregates, but also closely related to the dispersibility of the catalyst agglomerates. Effectively breaking the catalyst agglomerates into smaller aggregates is essential to enlarge the catalyst surface accessible to ionomers.

FIG. 4(b) shows the scattering curves of the catalyst inks with different H₂O content. Several kneelike power-law regimes were observed in scattering curves, which correspond to the multilevel structures of carbon-ionomer agglomerates, aggregates, and Pt nanoparticles. The scattering differences between the inks are evident in the agglomerate regions (low q range, <0.001 Å⁻¹), while the differences in the aggregate and Pt nanoparticle regions (intermediate and high q range, respectively) appear to be not significant. However, the radius of gyration of the agglomerates cannot be determined directly from USAXS due to the knee of the agglomerate scattered beyond the measuring range. The slope of intensity in the low q region is proportional to the mass fractal dimension, which could be used to qualitatively characterize the extent of agglomeration. The larger slope implies the denser agglomerates in the catalyst ink, and the more difficult it is for the agglomerate to break up into aggregate. The inset in FIG. 4 (b) shows the zoomed-in low q region of the scattering profiles. Obviously, the slope decreased with increasing the H₂O content in the range of 0˜90 wt. % H₂O, indicating that more H₂O is beneficial to breakup the agglomerates, which agreed well with the observations on other inks such as PtNi/Vu and PtNi/HSC catalysts in n-PA/H₂O mixed solvents. However, further increasing the H₂O content to 100 wt. % H₂O resulted in the largest slope, which could be attributed to the hydrophobic nature of pristine carbon particles. The size of Pt nanoparticles in different solvents remained almost unchanged, as the fitted average diameters in low q range slightly varied from 5.1 to 6.0 nm. The fitting results in intermediate q range show that the average diameters of the carbon-ionomer aggregates in different solvents varied from 262.8 to 290.6 nm, which followed a similar trend as observed in the agglomerate regions (low q range). The smaller sizes of catalyst-ionomer agglomerate/aggregate in the ink solvents are correlated reasonably well with the higher kinetic activities (mass activity and ECSA) in FIG. 1(c). Although the smaller sizes of ionomer aggregate were achieved with pure n-PA and pure H₂O, the large sizes of catalyst agglomerate/aggregate reduce the catalyst surface accessible to ionomers, resulting in the lowest kinetic activities.

V. Cryo-TEM Analysis

A 3.0 uL aliquot of the sample was placed on a glow discharged QUANTIFOIL® R1.2/1.3 300 mesh copper grid. It was then plunge frozen using FEI Vitrobot Mark III with 8 sec blotting at 20° C. The frozen grid was loaded into 200 kV Thermo Scientific Glacios™ Cryo Transmission Electron Microscope. Low dose images were recorded using Gatan K3 direct electron detector at ×45,000 nominal magnifications (0.88 Å/pixel) with total dose of 45 e/Å².

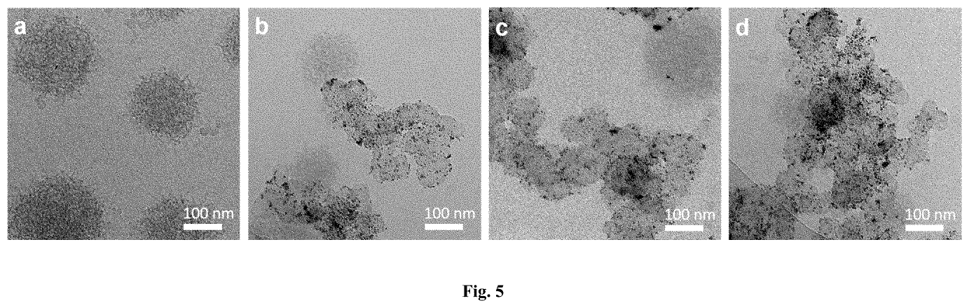

To validate the results from the USAXS data, cryo-TEM was used to visualize the aggregate sizes of ionomer and catalyst in the n-PA/H₂O mixed solvent with 90 wt. % H₂O. As evident in FIG. 5(a), the ionomer aggregates exhibited a spherical geometry with a diameter of 100-200 nm, which is consistent with the average diameter of 139 nm obtained from USAXS fitting. At low ionomer concentrations, Nafion ionomers are known to exist as rod-like primary particles in H₂O-rich solvents or coil-like primary particles in alcohol-rich solvents. The formation of rod-like primary particle in H₂O-rich solvents can be explained by the fact that sulfonic acid side chains preferentially orient toward the solvent interface due to H₂O-rich solvents are more compatible with the sulfonic acid side chains than with the perfluorocarbon backbones. The rod-like structure with 2 nm in diameter and 20 nm in length was demonstrated using USAXS and cryo-TEM techniques. The coil-like structure of ionomer primary particles was proposed with the perfluorocarbon backbones in contact with the alcohol-rich solvent and the sulfonic acid side chains buried inside the coiled structures. As ionomer concentration increased, the primary particles tend to form secondary aggregates via the inter-ionic interactions of side chain negatively charged —SO₃⁻ groups with positively charged H₃O⁺ ions or the inter-polymer perfluorocarbon backbone interactions. The aggregate structures of rod-like micelles and coil-like micelles were proposed in H₂O-rich and alcohol-rich solvents, respectively. FIG. 5(b) shows a typical cryo-TEM image of catalyst-ionomer aggregates in the catalyst ink with 90 wt. % H₂O. For catalyst aggregates of carbon supported Pt nanoparticles, some sphere carbon particles aggregated to form a rod-like aggregate with a diameter/length around 300 nm, in consistent with the USAXS data. The ionomer aggregates appeared to be adsorbed on the surface of catalyst aggregates, which could be attributed to the van der Waals force between ionomer aggregates and catalyst aggregates. The interaction between ionomer and catalyst in the ink is critical to the formation of catalyst/ionomer interface in the catalytic layer. In addition, the cryo-TEM images of catalyst inks with pure n-PA and pure H₂O are provided in FIG. 5(c, d), which demonstrated a similar morphology, but larger catalyst-ionomer aggregates compared with that of 90 wt. % H₂O. This result agreed well with the fitting results of USAXS data.

VI. Mercury Porosimetry

The pore size and specific pore volume distributions in the catalyst layers were measured using an Autopore IV 9520 mercury porosimeter (Micromeritics, Norcross, Ga.). Catalyst layer coated Nafion-212 membrane was cut into strips, and then used for mercury intrusion porosimetry test. During the testing, mercury was intruded into the porous catalyst layer progressively by applying an external pressure from 0.25 psia to 60000 psia with an equilibration time of 10 sec. The pore size was determined by using the Washburn equation, which establishes a direct relationship between the external pressure and the pore diameters.

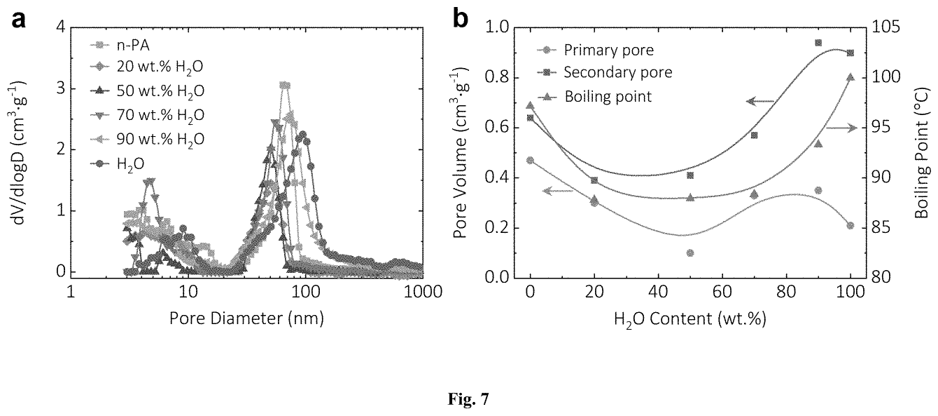

The pore size distributions in the catalyst layers fabricated with different solvents on Nafion membranes were investigated using mercury intrusion porosimetry. The contribution of Nafion membrane to the total pore volumes is negligible since no mercury intrusion can be observed within the measuring range. As evident in FIG. 7 (a), the catalyst layers exhibited two distinctive pore size distributions with a critical boundary of 20 nm, in good agreement with those reported previously. The primary pores in the range of 3˜20 nm can be attributed to the void spaces inside and between the primary particles in the carbon aggregates, while the secondary pores (>20 nm) correspond to the void spaces between the carbon aggregates. Obviously, the ionomer aggregates cannot infiltrate inside the primary pores because the ionomer aggregates (122.2˜170.0 nm) are much larger than the primary pores (<20 nm). Therefore, the ionomer aggregates should be mainly distributed on the surface of catalyst aggregates covering the surface of secondary pores, which act as ORR active sites due to the reaction requires the protons transport to the reaction sites to complete the conversion of oxygen to water.

As described herein, the primary pore size of the catalyst layers may be 1 nm or greater, 3 nm or greater, 5 nm or greater, 10 nm or greater, 15 nm or greater, 20 nm or greater, 25 nm or greater, 30 nm or lower, 35 nm or lower, 40 nm or lower, 45 nm or lower, 50 nm or lower, or within any range encompassed by any two of the foregoing values as endpoints.

As described herein, the secondary pore size of the catalyst layers may be 1 nm or greater, 3 nm or greater, 5 nm or greater, 10 nm or greater, 15 nm or greater, 20 nm or greater, 25 nm or greater, 30 nm or lower, 35 nm or lower, 40 nm or lower, 45 nm or lower, 50 nm or lower, 55 nm or lower, 60 nm or lower, or within any range encompassed by any two of the foregoing values as endpoints.

The specific volumes of the primary pores and secondary pores determined from FIG. 7 (a) are compared in FIG. 7 (b) and Table 3. Both specific volumes of the primary and secondary pores first decreased with the increase of H₂O content, then increased to the maximum volumes, and finally slightly decreased, which is very consistent with the variations of mass transport loss/resistance observed in FIG. 2(b) and FIG. 3(c). The lower mass transport loss/resistance could be directly linked to the larger specific pore volume, especially that of the secondary pores, which is critical in facilitating oxygen diffusion and mitigating the water flooding issues in improving the power density. The specific volume of the secondary pores reached the maximum values of 0.94 and 0.90 cm³·g⁻¹ with 90 wt. % H₂O and 100 wt. % H₂O, respectively, resulting in the lowest mass transport losses. Previous studies attributed the higher specific pore volumes in the catalyst layer to the larger catalyst-ionomer aggregates/agglomerates in the catalyst ink. However, this is difficult to explain the changes in the pore structure observed in this study. In order to clarify the change of specific pore volume for different catalyst layers, the boiling points of different mixed solvents are compared in FIG. 7 (b) and Table 2. The boiling point of the mixed solvent varied from 87.8° C. to 100° C. with the alteration of H₂O content. Generally, a lower boiling point implies a higher evaporation rate at a given temperature. The mixed solvents with 20 wt. % H₂O and 50 wt. % H₂O are closest to the azeotropic composition of 28.8 wt. % H₂O (87.7° C.), resulting in the lowest boiling points. It should be noted that, for mixed solvents with a non-azeotropic composition, the boiling point gradually increases as the evaporation progresses due to the changes in composition. As evident in FIG. 7 (b), the specific pore volumes, especially that of the secondary pores are closely related to the boiling points of the corresponding solvents. The solvent with a higher boiling point (away from azeotropic composition) helps to form more secondary pores. In this study, the catalyst layers were fabricated by directly ultrasonic spraying the catalyst ink onto the Nafion membranes placed on a hot vacuum plate (<80° C.) without post-drying or hot pressing. The microstructure of the catalyst layer was constructed during the solvent evaporation, as a result of accumulation of the catalyst-ionomer aggregates. Due to the evaporation of the dispersion solvents, the catalyst-ionomer aggregates in catalyst layer tend to form large aggregates or agglomerates. For a low boiling point solvent, the solvent quickly evaporates, and the mobility of the catalyst-ionomer aggregates is almost lost before the aggregates are packed densely. In this case, the size of catalyst-ionomer aggregates in the catalyst ink determines the pores structure of the ultimate catalyst layer, and the larger size of catalyst-ionomer aggregates in the ink constructs the larger pores in the catalyst layer. However, for a high boiling point solvent with a low evaporation rate, the catalyst-ionomer aggregates with a good mobility tends to agglomerate together during the solvent evaporation to form larger catalyst-ionomer aggregates, resulting in larger pores between the forming aggregates. The slower the solvent evaporation rate, the more time it has to coagulate into larger aggregates to form more secondary pores, which is similar to the process of evaporation-induced self-assembly.

VII. Scanning Electron Microscope

The surface and cross-section morphology of the catalyst layers were characterized using JEOL-7800 field emission scanning electron microscope (FESEM) (JEOL USA, MA). The fresh catalyst layer coated Nafion-212 membrane was cut in liquid nitrogen, and then used for microscopic tests.

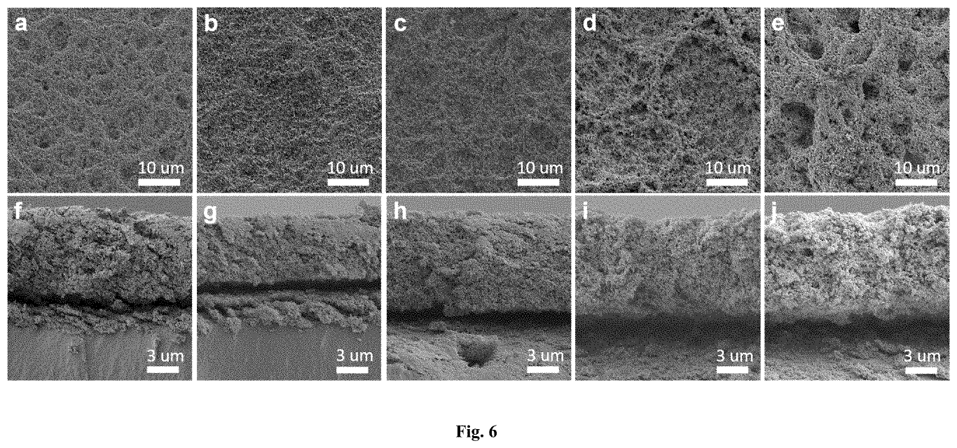

The surface and cross-sectional morphologies of the catalyst layers with different solvents were examined, and the corresponding SEM images are given in FIG. 6. Although the same catalyst and ionomer were used, the catalyst layers fabricated with different dispersing solvents exhibit apparently different microstructures. The catalyst layers with 20 wt. % H₂O and 50 wt. % H₂O had a relatively compact and smooth appearance, while the surface of other catalyst layers were rough and loose with obvious voids. Furthermore, large voids were observed for the catalyst layer fabricated with pure H₂O solvent. The catalyst layer with 90 wt. % H₂O (FIG. S3) exhibited a spider web-like porous structure similar to that with pure H₂O, which is not shown in FIG. 6 to simplify the description. Despite the difference in morphology, the thickness of all catalyst layers is 8˜10 μm due to the same catalyst and ionomer loadings.

VIII. H₂/O₂ Performances of MEAs

The H₂/O₂ performances of MEAs fabricated with different n-PA/H₂O mixed solvents are presented in FIG. 1(a). Obviously, the solvent composition has a significant effect on the MEA performance. The MEA fabricated with the n-PA/H₂O mixed solvent containing 90 wt. % H₂O demonstrated the best performance over the entire polarization range. The ohmic resistances remained almost unchanged with different H₂O contents, as evidenced by the severely overlapping iR drop curves at the bottom of FIG. 1(a). As is well-known, the MEA performance is dominated by polarization losses of kinetic activation, ohmic resistance and mass transport. Therefore, the performance differences in this study could be mainly attributed to different oxygen reduction reaction (ORR) kinetics and mass transport limitations of these MEAs. In FIG. 1(a), minor performance differences are observed at high cell voltages (>0.8 V). To further interpret the ORR kinetics of different MEAs, Tafel plots are constructed in FIG. 1(b). The Tafel slopes and mass activity (MA) values at 0.9 V_{iR-free} are summarized in Table 1. The Tafel slopes of MEAs were between 63.9 and 71.0 mV·dec⁻¹, which are close to the theoretical value of 70 mV·dec⁻¹. The mass activity varied from 140.2 to 189.4 mA·mg_{Pt}⁻¹ with the alteration of H₂O content. Mass activity and electrochemical surface area (ECSA) are practical indicators for evaluating the kinetic activity of different catalyst layers, which are compared in FIG. 1(c). Obviously, the mass activity significantly improved with increasing the H₂O content from 0 to 90 wt. % H₂O. The MEA with 90 wt. % H₂O delivered the highest mass activity of 189.4 mA·mg_{Pt}⁻¹, close to that obtained in the rotating disc electrode (RDE) (197.8 mA·mg_{Pt}⁻¹, Figure S1(b)). Further increasing the H₂O content to 100 wt. % H₂O resulted in a decrease of mass activity to 140.4 mA·mg_{Pt}⁻¹. For MEA with different H₂O content, the ECSA value varied from 42.9 to 52.0 m²·g_{Pt}⁻¹, which matched well with the trend of mass activities. The MEA with 90 wt. % H₂O delivered the largest ECSA value of 52.0 m²·g_{Pr}⁻¹, which was lower than that obtained in the RDE (64.0 m²·g_{Pt}⁻¹, Figure S1(a)). This could be explained by the fact that part of the active sites (Pt surface areas) in the catalyst layer are not available for the electrochemical reaction due to either insufficient contact with the ionomer or electrical isolation of catalyst particles from each other by the thick film of non-electronic conductive ionomer. The higher the ECSA value implies the more catalyst/ionomer interfaces (available active sites) throughout the catalyst layer.

Significant performance differences can be observed at low cell voltages (<0.8 V) in FIG. 1(a). For better comparison, the current densities are plotted against H₂O content at different cell voltages in FIG. 2(a). Except for the MEA fabricated with pure n-PA, the variation trends of current density with H₂O content basically followed the kinetic activity (FIG. 1(c)). Although the MEA made with pure n-PA solvent exhibited the lowest kinetic activity (FIG. 1(c)), its performance at high current density was better than the MEAs with 20 wt. % H₂O and 50 wt. % H₂O (FIG. 2(a)). This could be attributed to the different mass transport limitations of MEAs with different H₂O contents. Mass transport loss (ηₜₓ) is mainly caused by the poor oxygen diffusion through the catalyst layer, especially when the fuel cell is operated at high current densities, which can be calculated from polarization curve based on the equation (1).

E_{cell}=Eᵣₑᵥ−iR_{Ω}−η_{ORR}−ηₜₓ (1)

Here, Eᵣₑᵥ, E_{cell}, and i are the reversible cell voltage, the measured cell voltage, and current density, respectively. The ohmic loss (iR_{Ω}) is caused by the ohmic resistances of cell components and contact resistances between the components, as seen in FIG. 1(a), can be measured using current interrupt method. The kinetic overpotential (∂_{ORR}) originates from the sluggish ORR kinetics on the cathode catalyst layer, which can be obtained from the Tafel equation (η_{ORR} ∝b log i) derived from polarization curves at low current density region.^{32,35} FIG. 2(b) shows the derived voltage loss curves of mass transport for different MEAs. The mass transport loss appreciably increased at higher current densities due to serious oxygen diffusion and water flooding issues. The variation in mass transport loss of different MEAs matched well with that observed in FIG. 2(a), indicating the mass transport dominated the performance differences at high current densities. Mass transport resistances are closely related to the pore structure in the catalyst layer, because the reaction requires oxygen to be supplied to the catalyst particles through the pore channels. Appropriate pore structure in the catalyst layer is critical in facilitating oxygen diffusion and mitigating the water flooding issues.

As described herein, the catalyst layers may demonstrate a mass transport resistance of 150 mΩ·cm² or lower, 140 mΩ·cm² or lower, 130 mΩ·cm² or lower, 120 mΩ·cm² or lower, 110 mΩ·cm² or lower, 100 mΩ·cm² or lower, 90 mΩ·cm² or lower, 85 mΩ·cm² or lower, 80 mΩ·cm² or lower, 75 mΩ·cm² or lower, 70 mΩ·cm² or lower, 65 mΩ·cm² or lower, 60 mΩ·cm² or lower, 55 mΩ·cm² or lower, 50 mΩ·cm² or lower, 45 mΩ·cm² or lower, 40 mΩ·cm² or lower, 35 mΩ·cm² or lower, 30 mΩ·cm² or lower, 25 mΩ·cm² or lower, 20 mΩ·cm² or lower, 15 mΩ·cm² or lower, 10 mΩ·cm² or lower, 5 mΩ·cm² or lower, or 1 mΩ·cm² or lower.

Above all, the composition of the n-PA/H₂O mixed solvents played a critical role on the formation of the catalyst layer, and thus fuel cell performance. Varying the solvent composition resulted in the change of physical properties including dielectric constant, solubility, and boiling point. The dielectric constant and solubility of each mixed solvent affect the aggregates (catalyst and ionomer) size in the catalyst ink, which ultimately determined the catalyst/ionomer interface (available active sites) of the resulting catalyst layer. The smaller aggregates in the catalyst ink facilitated the formation of a better catalyst/ionomer interface, resulting in enhanced kinetic activity (mass activity and ECSA). On the other hand, the boiling point was closely related to the solvent evaporation rate during the ultrasonic spraying process, which governed the pore structure of the catalyst layer. The dispersion solvent with a low evaporation rate appeared to be beneficial in forming secondary pores, which are critical in facilitating oxygen transport and mitigating the water flooding issues.

As such, whereas particular embodiments of this invention have been described above for purposes of illustration, it will be evident to those skilled in the art that numerous variations of the details of the present invention may be made without departing from the invention as defined in the appended claims.

The following examples serve to further illustrate the disclosure as described herein and are not intended to limit the scope of the claims.

### EXAMPLES

### Example 1—Performance Testing of MEAs

The Tafel slopes and mass activity values of the MEAs were measured and the results are summarized in Table 1 below.

TABLE 1
Performance parameters of the MEAs fabricated with different n-PA/H2O mixed solvents

| | | | Peak power density | | |
|---|---|---|---|---|---|
| H₂O Content | Mass activity | Current density at 0.6 V | (H₂/air, | ECSA | Tafel slope |
| (wt. %) | (mA · mg_{Pt}⁻¹) | (H₂/air, mA · cm⁻²) | mW · cm⁻²) | (m² · g⁻¹) | (mV · dec⁻¹) |
| 0 | 140.5 | 1032 | 781 | 42.9 | 63.9 |
| 20 | 140.2 | 914 | 737 | 46.8 | 71.0 |
| 50 | 154.6 | 918 | 770 | 48.0 | 69.8 |
| 70 | 174.9 | 1035 | 797 | 50.5 | 66.1 |
| 90 | 189.4 | 1229 | 919 | 52.0 | 68.3 |
| 100 | 140.4 | 1158 | 858 | 43.6 | 65.8 |

### Example 2—Physical Properties of Mixed Solvents

The dielectric constant, solubility, and boiling point of different mixed solvents are compiled in Table 2 below.

TABLE 2
Physical parameters of different n-PA/H₂O mixed solvents.

| H₂O Content | Dielectric | | Boiling point |
|---|---|---|---|
| (wt. %) | constant | Solubility | (° C.) |
| 0 | 20 | 11.9 | 97.2 |
| 20 | 25 | 14.4 | 87.8 |
| 50 | 44 | 17.9 | 88.0 |
| 70 | 58 | 20.1 | 88.4 |
| 90 | 73 | 22.3 | 93.3 |
| 100 | 78 | 23.4 | 100.0 |
| Ionomer | | 9.7 (backbone) | |
| | | 17.3 (side chain) | |

### Example 3—Porosimetry of Catalyst Layers

The specific volumes of the primary and secondary pores determined from FIGS. 7(a) and 7(b) are compared below in Table 3.

TABLE 3
Porosimetry properties of the catalyst layers fabricated
with different n-PA/H₂O mixed solvents

| | Primary pore | | Secondary pore | |
|---|---|---|---|---|
| H₂O Content | Pore range | Pore volume | Pore range | Pore volume |
| (wt. %) | (nm) | (cm³ · g⁻¹) | (nm) | (cm³ · g⁻¹) |
| 0 | <20 | 0.47 | 20~400 | 0.64 |
| 20 | <20 | 0.30 | 20~108 | 0.39 |
| 50 | <20 | 0.10 | 20~340 | 0.41 |
| 70 | <20 | 0.33 | 20~1000 | 0.57 |
| 90 | <20 | 0.35 | 20~1000 | 0.94 |
| 100 | <20 | 0.21 | 20~1000 | 0.90 |

1. A catalyst ink composition comprising n-propanol and water, wherein the water is present in an amount of 90 wt. % based on the total weight of the composition.

2. The catalyst ink composition of claim 1, wherein the water is present in an amount of 50-90 wt. % based on the total weight of the composition.

3. A catalyst layer in a membrane electrode assembly comprising the catalyst ink composition of claim 1.

4. The catalyst layer of claim 2, wherein the catalyst/ionomer interface comprises primary pores with a pore size of about 3 nm or greater and a secondary pore size of about 20 nm or greater.

5. The catalyst layer of claim 2, wherein the mass transport resistance is lower than 85 mΩ·cm²

6. A polymer electrolyte membrane fuel cell comprising the catalyst ink of claim 1.
